(19) United States
(12) Patent Application Publication
(10) Pub. No.: US 2025/0206546 A1
(43) Pub. Date: Jun. 26, 2025

(54) Device and Method for Recovering and Re-Injecting Excess Powder

(71) Applicant: SK On Co., Ltd., Seoul (KR)

(72) Inventors: Ji Yun YANG, Daejeon (KR); Yeong Jun JI, Daejeon (KR)

(21) Appl. No.: 18/945,798

(22) Filed: Nov. 13, 2024

(30) Foreign Application Priority Data
Dec. 22, 2023 (KR) 10-2023-0190054

(51) Int. Cl. B65G 53/66; B65G 53/46

(52) U.S. Cl. CPC B65G 53/66; B65G 53/4608; B65G 2201/042; B65G 2812/1625; B65G 2812/165

(57) ABSTRACT

Proposed are a device and a method for recovering and re-injecting excess powder, in which the device includes one or more powder transfer lines transferring powder, a loading chamber loading the powder transferred through a first connecting pipe connected to the powder transfer lines, a storage hopper storing the loaded powder transferred by opening an opening/closing valve disposed at a lower end of the loading chamber, a powder weigher disposed on each side or one side of the loading chamber or the storage hopper, a rotary valve connected to a lower end of the storage hopper and normally discharging the powder stored in the storage hopper, a micro-rotary valve disposed at the storage hopper and recovering the powder exceeding a target supply amount, a recovery chamber connected to the micro-rotary valve and storing the recovered powder, and a controller controlling the rotary valve and the micro-rotary valve.

### CROSS REFERENCE TO RELATED APPLICATION

The present application claims priority to Korean Patent Application No. 10-2023-0190054, filed Dec. 22, 2023, the entire contents of which is incorporated herein for all purposes by this reference.

### BACKGROUND OF THE INVENTION

### Field of the Invention

The present disclosure relates to a device and a method for recovering and re-injecting excess powder.

### Description of the Related Art

A powder transfer device is a device that transfers powder ranging from fine powder to solid powder with a diameter of several cm. Conventional powder transfer devices include a screw conveyor type, a rope conveyor type, and a suction conveyor type. Of these, a vacuum conveyor-type powder transfer device is mainly used for rapid and safe transfer of powder raw materials.

In general, a vacuum conveyor-type powder transfer and weighing device is composed of a vacuum conveyor for transferring powder and a load cell for weighing powder.

The vacuum conveyor-type powder transfer and weighing device transfers a target amount of powder through the vacuum conveyor using a vacuum pump, and measures the transferred powder through the load cell. When the transferred powder measured in this manner does not reach the target amount, additional powder is transferred to achieve the target amount of powder.

Additional transfer of powder through the vacuum conveyor is generally accomplished by roughly controlling the amount of powder by turning the vacuum pump on/off or manipulating an analog dial. However, since this additional rough transfer of powder makes it difficult to transfer the powder precisely, a pinch valve and a vacuum break valve are further used to achieve a certain degree of precise weighing of the powder.

Despite these efforts, such an additional powder transfer method using the pinch valve and the vacuum break valve has limitations in precise powder weighing when transferring various types of powders with different specific gravities and compositions, especially when transferring small amounts of low-specific gravities powders, due to the characteristics of the secondary battery industry.

The foregoing is intended merely to aid in the understanding of the background of the present disclosure, and is not intended to mean that the present disclosure falls within the purview of the related art that is already known to those skilled in the art.

### DOCUMENTS OF RELATED ART

(Patent document 1) Korean Patent Application Publication No. 10-2020-0107146

### SUMMARY OF THE INVENTION

Accordingly, the present disclosure has been made keeping in mind the above problems occurring in the related art, and one objective of the present disclosure is to provide a device and a method for recovering and re-injecting excess powder.

In order to achieve the above objective, according to a first aspect of the present disclosure, there is provided a device for recovering and re-injecting excess powder, the device including: one or more powder transfer lines configured to transfer powder supplied from a powder supplier; a loading chamber configured to load the powder transferred through a first connecting pipe connected to the powder transfer lines; a storage hopper configured to store the loaded powder transferred by opening an opening/closing valve disposed at a lower end of the loading chamber; a powder weigher disposed on each side or one side of the loading chamber or the storage hopper; a rotary valve connected to a lower end of the storage hopper and configured to normally discharge the powder stored in the storage hopper; a micro-rotary valve disposed at the storage hopper and configured to recover the powder exceeding a target supply amount; a recovery chamber connected to the micro-rotary valve and configured to store the recovered powder; and a controller configured to control the rotary valve and the micro-rotary valve.

According to one embodiment, the controller may operate the rotary valve when an amount of the powder weighed by the powder weigher is equal to the target supply amount and operate the micro-rotary valve when the amount of the powder weighed by the powder weigher exceeds the target supply amount.

According to one embodiment, the device may further include: a first vacuum line connected to a second connecting pipe connected to the storage hopper; a second vacuum line connected to an upper portion of the recovery chamber; an air line connected to the upper portion of the recovery chamber and an end of the second vacuum line; a first vacuum valve disposed on the first vacuum line; a second vacuum valve disposed on the second vacuum line; and an air valve disposed on the air line. The controller may control operation of the first vacuum valve of the first vacuum line to transfer the powder to the storage hopper, control operation of the second vacuum valve of the second vacuum line to recover the powder into the recovery chamber, and control operation of the air valve of the air line to re-inject the powder into the storage hopper.

According to one embodiment, the micro-rotary valve may be selectively disposed at a specific position on at least one of a side surface of an upper portion of the storage hopper, a side surface of a lower portion of the storage hopper, and a side surface of the loading chamber to recover and re-inject the powder.

According to one embodiment, an air filter configured to filter air introduced through the air line may be disposed in the recovery chamber.

According to one embodiment, the controller may compare a cumulative number of operation cycles of the micro-rotary valve for discharge of excess powder with a preset number of operation cycles to determine whether the cumulative number of operation cycles exceeds the preset number of operation cycles, and the controller may control the micro-rotary valve to re-inject the powder recovered in the recovery chamber into the storage hopper through a recovery and re-injection line when the cumulative number of operation cycles of the micro-rotary valve for discharge of excess powder exceeds the preset number of operation cycles.

According to one embodiment, the controller may continue powder transfer through the powder transfer lines when the cumulative number of operation cycles of the micro-rotary valve for discharge of excess powder is less than the preset number of operation cycles.

According to one embodiment, the controller may open the first vacuum valve of the first vacuum line and close the second vacuum valve of the second vacuum line to form a vacuum when transferring the powder to the storage hopper.

According to one embodiment, the controller may close the first vacuum valve of the first vacuum line and open the second vacuum valve of the second vacuum line to form a vacuum when recovering the powder into the recovery chamber.

According to one embodiment, the controller may close the second vacuum valve of the second vacuum line and open the air valve of the air line to supply air when re-injecting the powder into the storage hopper.

According to a second aspect of the present disclosure, there is provided a method of recovering and re-injecting excess powder, the method including: a powder transfer step of transferring powder through one or more powder transfer lines, loading the power into a loading chamber, and transferring the loaded powder to a storage hopper; a powder weighing step of weighing the powder transferred to the storage hopper through a powder weigher disposed at the storage hopper; a comparison step of comparing, by a controller, an amount of the weighed powder with a preset target supply amount in order to determine whether the weighed powder exceeds the preset target supply amount; and a recovery step of discharging and recovering excess powder into the recovery chamber through the micro-rotary valve when the amount of the weighed powder exceeds the preset target supply amount.

According to one embodiment, the method may further include: a comparison step of comparing, by the controller, a cumulative number of operation cycles of the micro-rotary valve for discharge of excess powder with a preset number of operation cycles to determine whether the cumulative number of operation cycles exceeds the preset number of operation cycles; and a re-injection step of re-injecting, by the controller, the powder recovered in the recovery chamber into the storage hopper through a recovery and re-injection line when the cumulative number of operation cycles of the micro-rotary valve for discharge of excess powder exceeds the preset number of operation cycles.

According to one embodiment, the micro-rotary valve may be selectively disposed at a specific position on at least one of a side surface of an upper portion of the storage hopper, a side surface of a lower portion of the storage hopper, and a side surface of the loading chamber to recover and re-inject the powder.

According to one embodiment, the controller may continue powder transfer through the powder transfer lines when the cumulative number of operation cycles of the micro-rotary valve for discharge of excess powder is less than the preset number of operation cycles.

According to one embodiment, in the powder transfer step, when the powder is transferred through the one or more powder transfer lines, the controller may open a first vacuum valve of a first vacuum line connected to a vacuum pump forming a vacuum and close a second vacuum valve of a second vacuum line connected to an upper portion of the recovery chamber to form a vacuum.

According to one embodiment, in the recovery step, when the powder discharged by the micro-rotary valve is recovered into the recovery chamber, the controller may close a first vacuum valve of a first vacuum line and open a second vacuum valve of a second vacuum line to form a vacuum.

According to one embodiment, in the re-injection step, when the recovered powder is re-injected into the storage hopper through the recovery and re-injection line, the controller may close a second vacuum valve of a second vacuum line and open an air valve of an air line connected to the second vacuum line to supply air.

The features and advantages of the present disclosure will be more clearly understood from the following detailed description when taken in conjunction with the accompanying drawings.

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to the present disclosure, by recovering and re-injecting excess powder that exceeds a preset target supply amount, it is possible to improve precision of powder weighing, thereby reducing powder waste and transfer time.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram illustrating a device for recovering and re-injecting excess powder according to an embodiment;

FIG. 2 is a block diagram illustrating various arrangement positions of a micro-rotary valve according to an embodiment; and

FIG. 3 is a flowchart illustrating a method of recovering and re-injecting excess powder according to an embodiment.

### DETAILED DESCRIPTION OF THE INVENTION

The objectives, specific advantages, and novel features of the present disclosure will be more clearly understood from the following detailed description and preferable embodiments when taken in conjunction with the accompanying drawings, but the present disclosure is not necessarily limited thereto. Further, in the following description of the present disclosure, a detailed description of related known configurations or functions may be omitted to avoid obscuring the subject matter of the present disclosure.

The terminology used herein is for the purpose of describing particular embodiments only and is not intended to be limiting. As used herein, the singular forms are intended to include the plural forms as well, unless the context clearly indicates otherwise.

Also, shapes and sizes of the elements shown in the drawings may be schematically or exaggeratedly drawn to provide an easily understood description.

It will be further understood that the terms “comprise”, “include”, “have”, etc. when used in this specification, specify the presence of stated features (e.g., numerical values, functions, operations, components, or parts) but do not preclude the presence or addition of one or more other features.

It will be understood that, although the terms “one”, “other”, “another”, “first”, “second”, etc. may be used only to distinguish one element from another element, these elements should not be limited by these terms.

The embodiments described herein and the accompanying drawings are not intended to limit the present disclosure to any specific embodiments. It will be understood that the present disclosure encompasses various modifications, equivalents, and/or alternatives of the embodiments. Herein below, exemplary embodiments of the present disclosure will be described in detail with reference to the accompanying drawings.

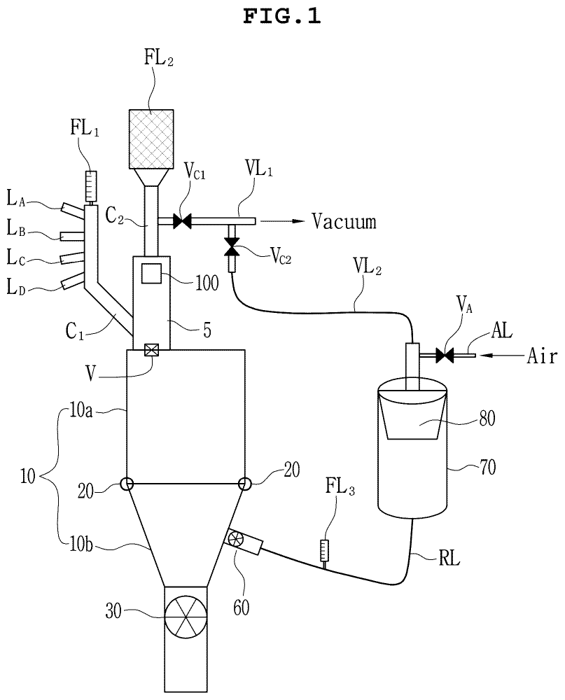

FIG. 1 is a block diagram illustrating a device for recovering and re-injecting excess powder according to an embodiment.

The device for recovering and re-injecting excess powder according to the present disclosure includes: one or more powder transfer lines L_{A}, L_{B}, L_{C}, and L_{D} transferring powder supplied from a powder supplier; a loading chamber 5 loading the powder transferred through a first connecting pipe C₁ connected to the powder transfer lines L_{A}, L_{B}, L_{C}, and L_{D}; a storage hopper 10 storing the loaded powder transferred by opening an opening/closing valve V disposed at a lower end of the loading chamber 5; a powder weigher 20 disposed on each side or one side of the loading chamber 5 or the storage hopper 10; a rotary valve 30 connected to a lower end of the storage hopper 10 and normally discharging the powder stored in the storage hopper 10; a micro-rotary valve 60 disposed at the loading chamber 5 or the storage hopper 10 and recovering the powder exceeding a target supply amount; a recovery chamber 70 connected to the micro-rotary valve 60 and storing the recovered powder; and a controller 100 disposed in the loading chamber 5 and operating the rotary valve 30 when an amount of the powder weighed by the powder weigher 20 is equal to the target supply amount and operating the micro-rotary valve 60 when the amount of the powder weighed by the powder weigher 20 exceeds the target supply amount.

Additionally, the micro-rotary valve 60 may be selectively disposed at a specific position on at least one of a side surface of an upper portion 10a of the storage hopper 10, a side surface of a lower portion 10b of the storage hopper 10, and a side surface of the loading chamber 5 to recover and re-inject the powder.

Additionally, the opening/closing valve V may be disposed between the loading chamber 5 and the storage hopper 10 and may be opened so that the powder transferred through the first connecting pipe C₁ and loaded in the loading chamber 5 is transferred to the storage hopper 10 or closed so that the powder stored in the storage hopper 10 does not flow back into the loading chamber 5, under the control of the controller 100.

One or more powder suppliers (not illustrated) for powder supply may use devices widely known to those skilled in the art, so a detailed description is omitted.

The device for recovering and re-injecting excess powder according to the present disclosure may further include: a first vacuum line VL₁ connected to a second connecting pipe C₂ connected to the storage hopper 10; a second vacuum line VL₂ connected to an upper portion of the recovery chamber 70; an air line AL connected to the upper portion of the recovery chamber 70 and an end of the second vacuum line VL₂; a first vacuum valve V_{C1} disposed on the first vacuum line VL₁; a second vacuum valve V_{C2} disposed on the second vacuum line VL₂; and an air valve V_{A} disposed on the air line AL.

A first end of the first connecting pipe C₁ may be connected to the upper portion 10a of the storage hopper 10, and a second end of the first connecting pipe C₁ may be connected to a first vacuum/air filter FL₁. Additionally, a first end of the second connecting pipe C₂ may be connected to the upper portion 10a of the storage hopper 10, and a second end of the second connecting pipe C₂ may be connected to a second vacuum/air filter FL₂.

A first end of the first vacuum line VL₁ may be connected to the upper portion 10a of the storage hopper 10 through the second connecting pipe C₂, and a second end of the first vacuum line VL₁ may be connected to a vacuum pump (not illustrated) that forms a vacuum. Additionally, the first vacuum valve V_{C1} is located between the second connecting pipe C₂ and the first vacuum line VL₁. With this configuration, when the vacuum pump is operated, a vacuum may be formed in the first vacuum line VL₁, and when the first vacuum valve V_{C1} is opened, a vacuum may be formed in the second connecting pipe C₂, thereby forming a vacuum in the storage hopper 10, so the powder may be transferred to the storage hopper 10 by the vacuum from the powder transfer lines L_{A}, L_{B}, L_{C}, and L_{D}.

Additionally, a first end of the second vacuum line VL₂ may be connected to the upper portion of the recovery chamber 70, and a second end of the second vacuum line VL₂ may be connected to the first vacuum line VL₁ connected to the vacuum pump. Additionally, the second vacuum valve V_{C2} may be located between the first vacuum line VL₁ and the second vacuum line VL₂. With this configuration, when the vacuum pump is operated, a vacuum may be formed in the first vacuum line VL₁, and when the second vacuum valve V_{C2} is opened, a vacuum may be formed in the second vacuum line VL₂, thereby forming a vacuum in the recovery chamber 70, so excess powder may be recovered from the storage hopper 10 to the recovery chamber 70 through a recovery and re-injection line RL.

Additionally, a first end of the recovery and re-injection line RL may be connected to the micro-rotary valve 60, and a second end of the recovery and re-injection line RL may be connected to a lower portion of the recovery chamber 70. A third vacuum/air filter FL₃ may be disposed on the recovery and re-injection line RL between the micro-rotary valve 60 and the recovery chamber 70. The air valve V_{A} may be located between the air line AL connected to an air pump (not illustrated) that supplies air and the recovery chamber 70. Additionally, an air filter 80 for filtering air introduced through the air line AL may be disposed in the recovery chamber 70. With this configuration, when the air pump is operated, air may be introduced through the air line AL, and when the air valve V_{A} is opened, the air may be introduced into the recovery chamber 70, so the powder may be re-injected into the storage hopper 10 through the recovery and re-injection line RL.

The controller 100 may control the operation of the opening/closing valve V for transferring the powder to the storage hopper 10 and the first vacuum valve V_{C1} of the first vacuum line VL₁, the operation of the second vacuum valve V_{C2} of the second vacuum line VL₂ for recovering the powder to the recovery chamber 70, and the operation of the air valve V_{A} of the air line AL for re-injecting the powder into the storage hopper 10.

Additionally, the controller 100 may control the operation of the vacuum pump for forming a vacuum and control the operation of the air pump for supplying air.

The detailed configuration of the controller 100 as described above and the operation control thereof are widely known to those skilled in the art, so a detailed description is omitted. Additionally, although the controller 100 is exemplified as being disposed in the loading chamber 5, the present disclosure is not limited thereto, and the controller 100 may be selectively disposed in an appropriate position as needed.

Meanwhile, the upper portion 10a of the storage hopper 10 may be directly connected to lower ends of the first and second connecting pipes C₁ and C₂. The first vacuum/air filter FL₁ may be disposed at an upper end of the first connecting pipe C₁ and the second vacuum/air filter FL₂ may be disposed at an upper end of the second connecting pipe C₂ to filter introduced air.

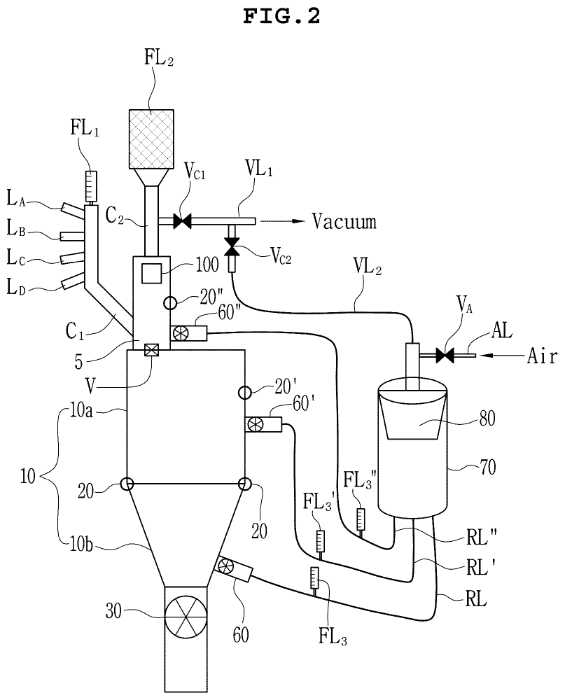

The powder weigher 20 may be disposed at an intermediate portion of the storage hopper 10 where the upper portion 10a and the lower portion 10b of the storage hopper 10 are connected, and may weigh the powder transferred to the storage hopper 10. Meanwhile, the position of the powder weigher 20 is not limited to the intermediate portion, and may be appropriately disposed on each side or one side of the loading chamber 5 or the storage hopper 10 as needed (see FIG. 2). Additionally, as described above, as an example of the powder weigher 20 for weighing the powder in the storage hopper 10, a conventional load cell may be used, but the present disclosure is not limited thereto.

The micro-rotary valve 60 may be disposed one side of the lower portion 10b of the storage hopper 10 and may discharge a small amount of excess powder according to the powder weighing.

A powder discharge amount discharged per one operation cycle of the micro-rotary valve 60 may be set to a range of 0.5% of a transfer amount supplied to the storage hopper 10. The basis for setting this range is because when the amount of the weighed powder exceeds 0.5 to 1.0% of a target amount preset in the process, the powder is considered excessive. Meanwhile, the set powder discharge amount discharged per operation cycle is not limited to the above range and may be changed according to process conditions. For example, the powder discharge amount may be appropriately changed depending on the size of the micro-rotary valve 60, etc.

Additionally, the micro-rotary valve 60 may be operated for a number of operation cycles preset by an operator, and the number of operation cycles may be appropriately changed depending on processes.

Meanwhile, the operation of the micro-rotary valve 60 and the rotary valve 30 as described above may be controlled by a motor (not illustrated) connected to the micro-rotary valve 60 and the rotary valve 30 according to the weighing result of the transferred powder by the controller 100.

The recovery chamber 70 may be connected to a first end of the micro-rotary valve 60 through the recovery and re-injection line RL and may recover excess powder discharged by the micro-rotary valve 60.

The capacity of the recovery chamber 70 may be designed to be approximately 20 liters (L), but the present disclosure is not limited thereto, and may be appropriately set depending on the type of powder and processing processes.

That is, when the amount of the powder to be recovered is set to 500 g and the density of the powder is set to 0.5 g/cm³, the capacity of the recovery chamber 70 may be set to a capacity (e.g., 20 liters) that can re-inject the recovered powder after 10 to 20 times of powder recovery.

For example, when a target powder recovery amount to be recovered to the recovery chamber 70 with the capacity of 20 liters is set to 10 kg and the number of times the powder is recovered is set to 10, the powder discharge amount discharged per one operation cycle (i.e., the number of operation cycles is 1) of the micro-rotary valve 60 may be 1 kg. Additionally, when the target powder recovery amount to be recovered to the recovery chamber 70 is set to 10 kg and the number of times the powder is recovered is set to 20, the powder discharge amount discharged per one operation cycle of the micro-rotary valve 60 may be 0.5 kg.

Therefore, the number of operation cycles (e.g., one of 10 to 20 times) of the micro-rotary valve 60 that can fill the recovery chamber 70 with a target powder recovery amount of 10 kg to be recovered may be preset according to the type and size of the powder.

In this regard, the controller 100 may compare a cumulative number of operation cycles (x) of the micro-rotary valve 60 for discharge of excess powder with a preset number of operation cycles (n) to determine whether the cumulative number of operation cycles (x) exceeds the preset number of operation cycles (n).

Thereafter, the controller 100 may control the powder recovered in the recovery chamber 70 to be re-injected into the storage hopper 10 through the recovery and re-injection line RL when the cumulative number of operation cycles (x) of the micro-rotary valve 60 for discharge of excess powder exceeds the preset number of operation cycles (n).

However, when the cumulative number of operation cycles (x) of the micro-rotary valve 60 for discharge of excess powder is less than the preset number of operation cycles (n), the controller 100 may continue powder transfer through the powder transfer lines L_{A}, L_{B}, L_{C}, and L_{D}.

Meanwhile, the number of operation cycles (n) of the micro-rotary valve 60 for discharge of excess powder may be preset according to the type of powder supplied and powder processing processes.

Additionally, the preset target supply amount and the preset number of operation cycles described above may be stored in a storage unit (not illustrated) of the controller 100 and may be used by the controller 100 when performing weighing of the powder weigher 20, discharge of the micro-rotary valve 60, and recovery operation of the recovery chamber 70. When performing these operations, the value measured by the powder weigher 20 and the cumulative number of operation cycles may be transmitted to the controller 100 and compared with the preset target supply amount and the preset number of operation cycles.

When the powder is transferred through one or more powder transfer lines L_{A}, L_{B}, L_{C}, and L_{D}, the controller 100 may open the first vacuum valve V_{C1} of the first vacuum line VL₁ connected to the vacuum pump forming a vacuum and close the second vacuum valve V_{C2} of the second vacuum line VL₂ to form a vacuum.

Additionally, when the powder discharged by the micro-rotary valve 60 is recovered to the recovery chamber 70, the controller 100 may close the first vacuum valve V_{C1} of the first vacuum line VL₁ and open the second vacuum valve V_{C2} of the second vacuum line VL₂ to form a vacuum.

Furthermore, when the recovered powder is re-injected into the storage hopper 10 through the recovery and re-injection line RL, the controller 100 may close the second vacuum valve V_{C2} of the second vacuum line VL₂ and open the air valve V_{A} of the air line AL to supply air. However, the air valve V_{A} may be always closed except when the recovered powder is re-injected into the storage hopper 10 in a reverse direction.

Additionally, when weighing powder through the powder weigher 20, all the valves may be closed because no process changes that may interfere with weighing have not to occur in order to ensure accurate weighing.

FIG. 2 is a block diagram illustrating various arrangement positions (i.e., connection positions) of a micro-rotary valve according to an embodiment.

As illustrated in FIG. 2, each micro-rotary valve 60, 60′, 60″ may be selectively disposed at a specific position on at least one of the side surface of the upper portion 10a of the storage hopper 10, the side surface of the lower portion 10b of the storage hopper 10, and the side surface of the loading chamber 5 so as to enable recovery and re-injection of the powder.

That is, each micro-rotary valve 60, 60′, 60″ may be selectively disposed at any appropriate position on the side surface of the upper portion 10a of the storage hopper 10, any appropriate position on the side surface of the lower portion 10b of the storage hopper 10, and any appropriate position on the side surface of the loading chamber 5 as needed in the process.

Meanwhile, like the above-described micro-rotary valve 60, each micro-rotary valve 60′, 60″ may be connected to the recovery chamber 70 through each recovery and re-injection line RL′, RL″ on which each third vacuum/air filter FL₃′, FL₃″ is disposed so as to recover and re-inject the powder.

Additionally, as illustrated in FIG. 2, each powder weigher 20, 20′, 20″ for weighing the powder in the storage hopper 10 and the loading chamber 5 may be disposed correspondingly to the position of each micro-rotary valve 60, 60′, 60″ to weigh the powder, or only one powder weigher may be disposed at an appropriate position to weigh the powder in the storage hopper 10 and the loading chamber 5 under the control of the controller 100.

Herein below, a method of recovering and re-injecting excess powder will be described in detail.

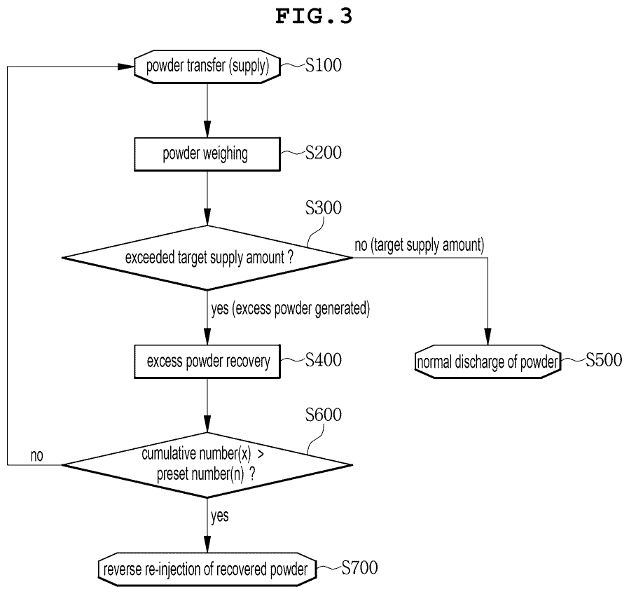

FIG. 3 is a flowchart illustrating a method of recovering and re-injecting excess powder according to an embodiment.

The method of recovering and re-injecting excess powder according to the present disclosure may include: a powder transfer step S100 of transferring powder through one or more powder transfer lines L_{A}, L_{B}, L_{C}, and L_{D}, loading the power into a loading chamber 5, and transferring the loaded powder to a storage hopper 10; a powder weighing step S200 of weighing the powder transferred to the storage hopper 10 through a powder weigher 20 disposed at the storage hopper 10; a comparison step S300 of comparing, by a controller 100 disposed in the loading chamber 5, an amount of the weighed powder with a preset target supply amount in order to determine whether the weighed powder exceeds the preset target supply amount; and a recovery step S400 of discharging and recovering excess powder into the recovery chamber 70 through the micro-rotary valve 60 when the amount of the weighed powder exceeds the preset target supply amount.

First, in the powder transfer step S100, powders having different specific gravity and composition supplied from one or more powder suppliers may be transferred to the storage hopper through at least one of the powder transfer lines L_{A}, L_{B}, L_{C}, and L_{D}.

In powder transfer as described above, a desired type of powder may be supplied through the powder transfer lines L_{A}, L_{B}, L_{C}, and L_{D} corresponding to powders A, B, C, and D according to a desired product process.

Meanwhile, in the powder transfer step S100, when the powder is transferred through one or more powder transfer lines L_{A}, L_{B}, L_{C}, and L_{D}, the controller 100 may open a first vacuum valve V_{C1} of a first vacuum line VL₁ connected to a vacuum pump forming a vacuum and close a second vacuum valve V_{C2} of a second vacuum line VL₂ connected to an upper portion of the recovery chamber 70 to form a vacuum.

Next, in the powder weighing step S200, the powder transferred to the storage hopper 10 may be weighed by the powder weigher 20 disposed at the storage hopper 10. In this case, a load cell may be used as the powder weigher 20, but the present disclosure is not limited thereto.

When weighing powder through the powder weigher 20, all the valves may be closed because no process changes that may interfere with weighing have not to occur in order to ensure accurate weighing.

Next, in the comparison step S300, the controller 100 may compare the amount of the weighed powder with the preset target supply amount to determine whether the amount of the weighed powder exceeds the preset target supply amount.

Meanwhile, in the comparison step S300, the target supply amount for comparison with the amount of the weighed powder may be appropriately set according to the type of powder and processing processes and stored in the storage unit of the controller 100.

In the comparison step S300, when the amount of the weighed powder exceeds the preset target supply amount, excess powder may be discharged to the recovery chamber 70 through the micro-rotary valve 60 and recovered in the recovery step S400.

However, when the amount of the weighed powder is less than the preset target supply amount, the powder transfer step S100 is performed again to supply more powder.

Additionally, when the amount of the weighed powder matches the preset target supply amount, the powder matching the target supply amount may be normally discharged through a rotary valve 30 in a discharge step S500.

In the discharge step S500, a powder discharge amount discharged per one operation cycle of the micro-rotary valve 60 may be set to a range of 0.5% of a transfer amount supplied to the storage hopper 10. The basis for setting this range is because when the amount of the weighed powder exceeds 0.5 to 1.0% of a target amount preset in the process, the powder is considered excessive.

In the recovery step S400, when the powder discharged by the micro-rotary valve 60 is recovered to the recovery chamber 70, the controller 100 may close the first vacuum valve V_{C1} of the first vacuum line VL₁ and open the second vacuum valve V_{C2} of the second vacuum line VL₂ to form a vacuum.

Additionally, the method of recovering and re-injecting excess powder may further include a comparison step S600 of comparing, by the controller 100, a cumulative number of operation cycles (x) of the micro-rotary valve 60 for discharge of excess powder with a preset number of operation cycles (n) to determine whether the cumulative number of operation cycles (x) exceeds the preset number of operation cycles (n).

Meanwhile, the number of operation cycles (n) of the micro-rotary valve 60 for discharge of excess powder may be appropriately set according to the type of powder supplied and powder processing processes and stored in the storage unit of the controller 100.

Additionally, the method of recovering and re-injecting excess powder may further include a re-injection step S700 of re-injecting, by the controller 100, the powder recovered in the recovery chamber 70 into the storage hopper 10 through a recovery and re-injection line RL when it is determined that the cumulative number of operation cycles (x) of the micro-rotary valve 60 for discharge of excess powder exceeds the preset number of operation cycles (n) in the comparison step S600.

In the re-injection step S700, when the recovered powder is re-injected into the storage hopper 10 through the recovery and re-injection line RL, the controller 100 may close the second vacuum valve V_{C2} of the second vacuum line VL₂ and open an air valve V_{A} of an air line AL connected to the second vacuum line VL₂ to supply air.

However, when it is determined that the cumulative number of operation cycles (x) of the micro-rotary valve 60 for discharge of excess powder is less than the preset number of operation cycles (n) in the comparison step S600, the controller 100 may continue powder transfer through the powder transfer lines L_{A}, L_{B}, L_{C}, and L_{D}.

That is, when the cumulative number of operation cycles (x) is less than the preset number of operation cycles (n), the powder transfer step S100 may be continuously repeated until the cumulative number of operation cycles (x) exceeds the preset number of operation cycles (n).

When repeatedly performing powder transfer as described above, as in the powder transfer step S100, the controller 100 may open the first vacuum valve V_{C1} of the first vacuum line VL₁ connected to the vacuum pump forming a vacuum and close the second vacuum valve V_{C2} of the second vacuum line VL₂ connected to the upper portion of the recovery chamber 70 to form a vacuum.

As described above, according to the device and method for recovering and re-injecting excess powder according to the present disclosure, by re-injecting excess powder that exceeds the preset target supply amount recovered from the storage hopper to the recovery chamber into the storage hopper, it is possible to improve precision of powder weighing, thereby reducing powder waste and transfer time.

The present disclosure has been described in detail through specific embodiments. The embodiments are intended to be used only for concretely describing the present disclosure, but the present disclosure is not limited thereto. It will be understood by those skilled in the art that the present disclosure can be modified or changed in various forms without departing from the technical spirit of the present disclosure.

Simple modifications or changes of the present disclosure belong to the scope of the present disclosure, and the detailed scope of the present disclosure will be more clearly understood by the accompanying claims.

What is claimed is:

1. A device for recovering and re-injecting excess powder, the device comprising:
one or more powder transfer lines configured to transfer powder supplied from a powder supplier;
a loading chamber configured to load the powder transferred through a first connecting pipe connected to the powder transfer lines;
a storage hopper configured to store the loaded powder transferred by opening an opening/closing valve disposed at a lower end of the loading chamber;
a powder weigher disposed on each side or one side of the loading chamber or the storage hopper;
a rotary valve connected to a lower end of the storage hopper and configured to normally discharge the powder stored in the storage hopper;
a micro-rotary valve disposed at the storage hopper and configured to recover the powder exceeding a target supply amount;
a recovery chamber connected to the micro-rotary valve and configured to store the recovered powder; and
a controller configured to control the rotary valve and the micro-rotary valve.

2. The device of claim 1, wherein the controller operates the rotary valve when an amount of the powder weighed by the powder weigher is equal to the target supply amount and operates the micro-rotary valve when the amount of the powder weighed by the powder weigher exceeds the target supply amount.

3. The device of claim 1, further comprising:
a first vacuum line connected to a second connecting pipe connected to the storage hopper;
a second vacuum line connected to an upper portion of the recovery chamber;
an air line connected to the upper portion of the recovery chamber and an end of the second vacuum line;
a first vacuum valve disposed on the first vacuum line;
a second vacuum valve disposed on the second vacuum line; and
an air valve disposed on the air line,
wherein the controller controls operation of the first vacuum valve of the first vacuum line to transfer the powder to the storage hopper,
controls operation of the second vacuum valve of the second vacuum line to recover the powder into the recovery chamber, and
controls operation of the air valve of the air line to re-inject the powder into the storage hopper.

4. The device of claim 3, wherein the micro-rotary valve is selectively disposed at a specific position on at least one of a side surface of an upper portion of the storage hopper, a side surface of a lower portion of the storage hopper, and a side surface of the loading chamber to recover and re-inject the powder.

5. The device of claim 3, wherein an air filter configured to filter air introduced through the air line is disposed in the recovery chamber.

6. The device of claim 2, wherein the controller compares a cumulative number of operation cycles of the micro-rotary valve for discharge of excess powder with a preset number of operation cycles to determine whether the cumulative number of operation cycles exceeds the preset number of operation cycles, and
the controller controls the micro-rotary valve to re-inject the powder recovered in the recovery chamber into the storage hopper through a recovery and re-injection line when the cumulative number of operation cycles of the micro-rotary valve for discharge of excess powder exceeds the preset number of operation cycles.

7. The device of claim 6, wherein the controller continues powder transfer through the powder transfer lines when the cumulative number of operation cycles of the micro-rotary valve for discharge of excess powder is less than the preset number of operation cycles.

8. The device of claim 3, wherein the controller opens the first vacuum valve of the first vacuum line and closes the second vacuum valve of the second vacuum line to form a vacuum when transferring the powder to the storage hopper.

9. The device of claim 3, wherein the controller closes the first vacuum valve of the first vacuum line and opens the second vacuum valve of the second vacuum line to form a vacuum when recovering the powder into the recovery chamber.

10. The device of claim 3, wherein the controller closes the second vacuum valve of the second vacuum line and opens the air valve of the air line to supply air when re-injecting the powder into the storage hopper.

11. A method of recovering and re-injecting excess powder, the method comprising:
a powder transfer step of transferring powder through one or more powder transfer lines, loading the power into a loading chamber, and transferring the loaded powder to a storage hopper;
a powder weighing step of weighing the powder transferred to the storage hopper through a powder weigher disposed at the storage hopper;
a comparison step of comparing, by a controller, an amount of the weighed powder with a preset target supply amount in order to determine whether the weighed powder exceeds the preset target supply amount; and
a recovery step of discharging and recovering excess powder into the recovery chamber through the micro-rotary valve when the amount of the weighed powder exceeds the preset target supply amount.

12. The method of claim 11, further comprising:
a comparison step of comparing, by the controller, a cumulative number of operation cycles of the micro-rotary valve for discharge of excess powder with a preset number of operation cycles to determine whether the cumulative number of operation cycles exceeds the preset number of operation cycles; and
a re-injection step of re-injecting, by the controller, the powder recovered in the recovery chamber into the storage hopper through a recovery and re-injection line when the cumulative number of operation cycles of the micro-rotary valve for discharge of excess powder exceeds the preset number of operation cycles.

13. The method of claim 12, wherein the micro-rotary valve is selectively disposed at a specific position on at least one of a side surface of an upper portion of the storage hopper, a side surface of a lower portion of the storage hopper, and a side surface of the loading chamber to recover and re-inject the powder.

14. The method of claim 12, wherein the controller continues powder transfer through the powder transfer lines when the cumulative number of operation cycles of the micro-rotary valve for discharge of excess powder is less than the preset number of operation cycles.

15. The method of claim 11, wherein in the powder transfer step, when the powder is transferred through the one or more powder transfer lines, the controller opens a first vacuum valve of a first vacuum line connected to a vacuum pump forming a vacuum and closes a second vacuum valve of a second vacuum line connected to an upper portion of the recovery chamber to form a vacuum.

16. The method of claim 11, wherein in the recovery step, when the powder discharged by the micro-rotary valve is recovered into the recovery chamber, the controller closes a first vacuum valve of a first vacuum line and opens a second vacuum valve of a second vacuum line to form a vacuum.

17. The method of claim 12, wherein in the re-injection step, when the recovered powder is re-injected into the storage hopper through the recovery and re-injection line, the controller closes a second vacuum valve of a second vacuum line and opens an air valve of an air line connected to the second vacuum line to supply air.
